(19) United States
(12) Patent Application Publication
(10) Pub. No.: US 2006/0073719 A1
(43) Pub. Date: Apr. 6, 2006

(54) Multiple key position plug

(76) Inventor: Massi E. Kiani, Laguna Niguel, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/238,634

(22) Filed: Sep. 29, 2005

Related U.S. Application Data
(60) Provisional application No. 60/614,321, filed on Sep. 29, 2004.

(51) Int. Cl. H01R 13/44

(52) U.S. Cl. 439/134

(57) ABSTRACT

A plug body is adapted to mesh with a corresponding socket body disposed on a pulse oximeter. Plug contacts are disposed within the plug body and electrically connected to conductors of a cable. The plug contacts are adapted to mesh with socket contacts disposed within the socket body so as to provide electrical communications between a sensor connected at a sensor end of the cable with the pulse oximeter connected at the monitor end of the cable. A fixed plug key of the plug body is adapted to accommodate a socket key of the socket body, where the socket key may be disposed at multiple key positions.

### CROSS-REFERENCE TO RELATED APPLICATIONS

This application relates to and claims the benefit of U.S. Provisional Application No. 60/614,321 entitled Multiple Key Position Plug, filed Sep. 29, 2004 and incorporated by reference herein.

### BACKGROUND OF THE INVENTION

Pulse oximetry is a widely accepted noninvasive procedure for measuring the oxygen saturation level of arterial blood, an indicator of a person's oxygen supply. Early detection of low blood oxygen level is critical in the medical field, for example in critical care and surgical applications, because an insufficient supply of oxygen can result in brain damage and death in a matter of minutes. FIG. 1 illustrates a pulse oximetry system 100 having a sensor 110, a monitor 105, and a patient cable 140 connecting the sensor and the monitor. The sensor 110 has emitters 120 and a detector 130 and is adapted to attach to a tissue site. The emitters 120 are configured to transmit light having at least red and infrared wavelengths into a tissue site. The detector 130 generates a signal responsive to the intensity of the emitter transmitted light after attenuation by the tissue site. The patient cable 140 communicates drive signals 152 from the monitor 105 to the emitters 120 and a resulting sensor signal 172 from the detector 130 to the monitor 105. The monitor 105 processes the sensor signal 172 to determine a person's oxygen saturation and pulse rate. A pulse oximetry sensor is described in U.S. Pat. No. 6,088,607 entitled Low Noise Optical Probe, which is assigned to Masimo Corporation, Irvine, Calif. and incorporated by reference herein.

Also shown in FIG. 1, the monitor 105 has drivers 150, a controller 160, a front-end 170, a signal processor 180 and a display 190. The drivers 150 alternately activate the emitters 120 as determined by the controller 160. The front-end 170 conditions and digitizes the sensor signal 172, which is utilized by the signal processor 180 to calculate oxygen saturation and pulse rate and to provide the results to the display 190. A pulse oximetry monitor is described in U.S. Pat. No. 5,482,036 entitled Signal Processing Apparatus and Method, which is assigned to Masimo Corporation, Irvine, Calif. and incorporated by reference herein.

FIGS. 2A-B illustrate embodiments of monitor-mounted sockets 200, 205 adapted to mate with compatible plugs so as to connect a sensor or combination sensor and patient cable to a pulse oximetry monitor. Each socket 200, 205 has a D-shaped body 210 defining a centered, generally cylindrical cavity 220. Disposed around the cavity 220 and countersunk within the body 210 are socket contacts 230 that accept corresponding pins comprising plug contacts. Disposed on the wall of, and extending into the cavity 220 is a semi-circular cross-section key 250, 260, which may be located at any number of alternative positions. As shown in FIG. 2A, key 250 is located at a first position generally aligned to the overall D-shaped body 210. As shown in FIG. 2B, key 260 is located at a second position generally 45° askew to the overall D-shaped body 210, i.e. shifted 45° from the first key position relative to the cavity axis.

### SUMMARY OF THE INVENTION

Keyed connectors prevent the inadvertent coupling of incompatible components or wirings. A patient cable having a multiple key position monitor plug advantageously allows an electrical and mechanical connection between an otherwise compatible sensor and cable and any of a family of pulse oximetry monitors having keyed sockets with keys at a variety of positions corresponding to each type of monitor within that family. In particular, the multiple key position plug is configured to accommodate a plurality of key positions in corresponding monitor-mounted, keyed sockets, as shown and described with respect to FIGS. 3-4, below.

One aspect of a multiple key position plug is configured to mate with a corresponding socket mounted on a pulse oximeter so as to mechanically and electrically connect a cable to the pulse oximeter. The plug comprises an insulating plug body adapted to mesh with an insulating socket body of the socket. Conductive plug contacts are disposed within the plug body and adapted to insert into corresponding conductive socket contacts disposed within the socket body. A fixed plug key defined by the plug body is adapted to accommodate a socket key defined by the socket body at any one of multiple key positions. In one embodiment, the multiple key position plug has a generally cylindrical post extending from the plug body. The post is configured to insert into a corresponding cavity defined within the socket body. The fixed plug key is a groove defined along the post and adapted to accommodate the socket key, which extends into the cavity at any one of various positions. For example, the socket key may have a generally semi-circular cross-section and be located at either of two positions disposed 45° apart relative to the cylindrical axis of the cavity. In particular embodiments, the groove may have a cross-section with a generally crescent shape, the shape of two intersecting semicircles or the shape of a semi-circle comprising half the cylindrical cross-section of the cavity. In one particular embodiment, the groove is at least a substantial portion of the post.

Another aspect of a multiple key position plug provides a cable adapted to communicate signals between a sensor and a pulse oximetry monitor. A plug is attached at a monitor end of the cable and is adapted to mate with a corresponding socket of the monitor. The socket has a socket key located at one of multiple positions within the socket so as to block the insertion of an incompatible plug. A fixed plug key is configured so that the socket key does not block the insertion of the plug when the socket key is located at any of those multiple positions. In one embodiment, the socket comprises a generally cylindrical cavity configured to accept a generally cylindrical post of the plug, and at least a portion of the post is shaped so as to accommodate the socket key at the multiple positions. For example, the post may be grooved according to a socket key that may be located at either of two positions generally spaced 45° apart relative to an axis of the cavity. The cross-section of the groove may generally match the contour of the socket key at each of the two positions.

A further aspect of a multiple key position plug comprises a cable means, a plug body means, a plurality of plug conductor means disposed in said plug body means and a fixed plug key means defined in the plug body means. The cable means is for providing communications between a pulse oximeter and a sensor. The plug body means is for mating with a corresponding socket body disposed on the pulse oximeter. The plug conductor means are for electrical connection between the cable means and a plurality of socket conductors disposed within the socket body. The fixed plug key means is for accommodating a socket key defined in the socket body at each of various positions. For example, the fixed plug key means may comprise a post means of the plug body means for inserting into a corresponding cavity of the socket body and a groove means for shaping the post means to clear the socket key at any of the various positions.

Yet another aspect of multiple key position plug is a plug body adapted to mesh with a corresponding socket body disposed on a pulse oximeter. Plug contacts are disposed within the plug body. The plug contacts are adapted to mesh with corresponding socket contacts disposed within the socket body. The plug contacts are electrically connected to cable conductors so as to provide electrical communications between a sensor connected at a sensor end of the cable and a pulse oximeter connected at a monitor end of the cable. A fixed plug key of the plug body is adapted to accommodate a socket key of the socket body disposed at any one of various key positions. In one embodiment, a post extends from the plug body and is adapted to insert into a corresponding cavity extending into the socket body. The socket key extends from a wall of the cavity and the fixed plug key comprising a groove defined by the post so as to accommodate the socket key located at any one of the various positions. The post and the cavity may be generally cylindrical. The groove may have a generally crescent-shaped cross-section configured to accommodate a socket key having a generally semi-circular cross-sectioned disposed at either of two positions displaced generally 45° apart relative to the longitudinal axis of the cylindrical cavity. In an alternative embodiment, the fixed plug key may be accomplished by removal or deletion of the plug post.

### BRIEF DESCRIPTION OF THE DRAWINGS

FIG. 1 is a block diagram of a pulse oximetry system;

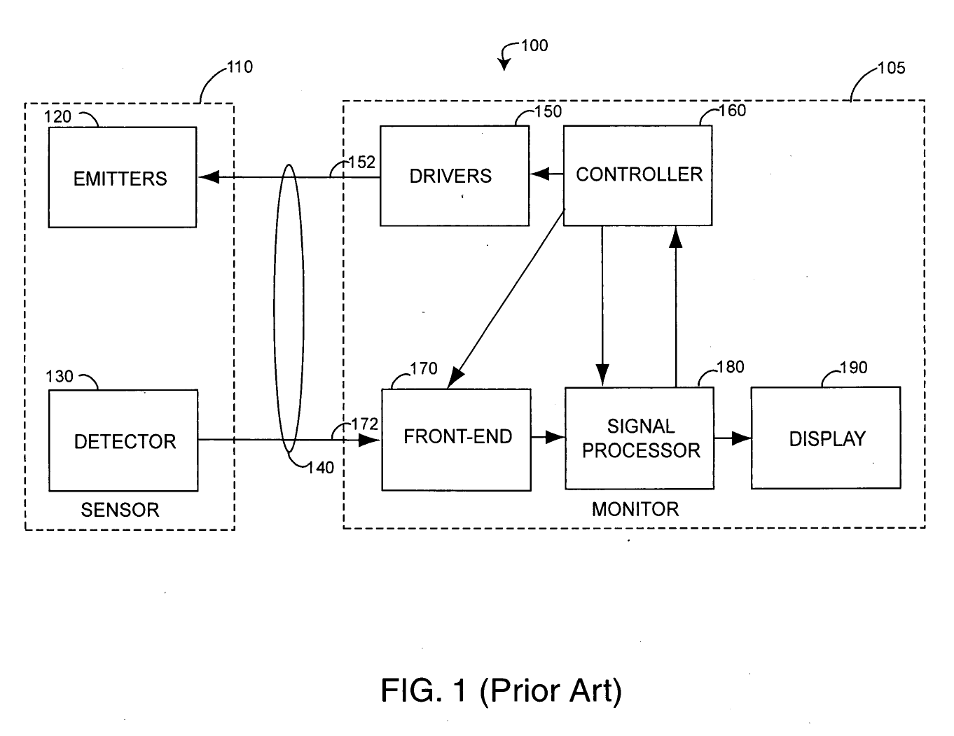

FIGS. 2A-B are end-views of monitor-mounted keyed sockets;

FIGS. 3A-C are monitor-end, side and sensor-end views, respectively, of one embodiment of a patient cable; and

FIGS. 4A-D are end views of various embodiments of multiple key position plugs.

### DETAILED DESCRIPTION OF THE PREFERRED EMBODIMENTS

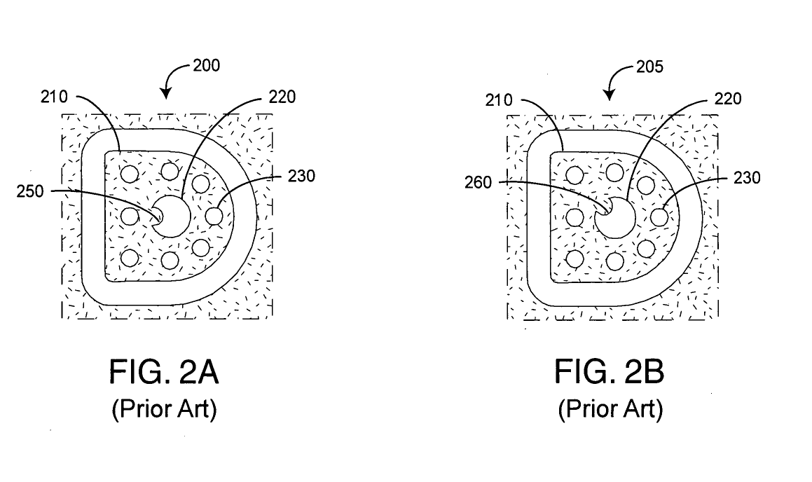

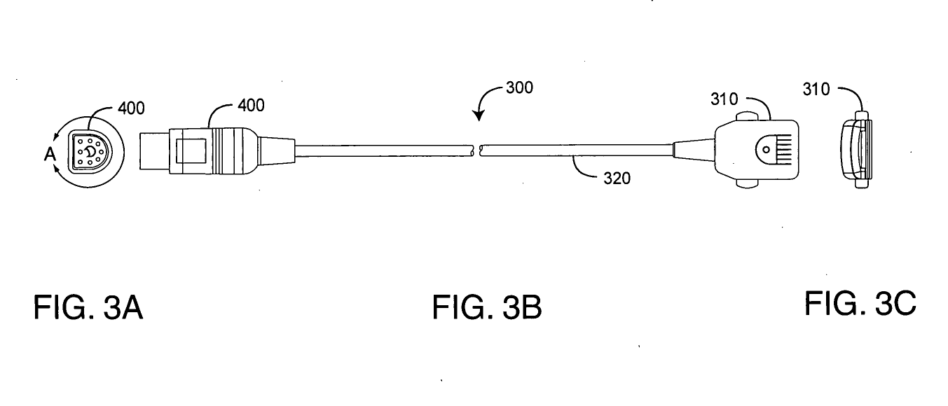

FIGS. 3A-C illustrate a patient cable 300 for connecting a pulse oximeter sensor to a corresponding monitor. The patient cable 300 has a sensor connector 310 at a sensor end and a multiple key position plug 400 at a monitor end. Advantageously, the multiple key position plug 400 is compatible with multiple key positions in a corresponding monitor-mounted socket. In a particular embodiment, the plug 400 is configured to insert into and electrically connect with a keyed socket 200 (FIG. 2A), 205 (FIG. 2B) having a key disposed at either of two different key positions. A sensor connector is described in U.S. Pat. No. 6,152,754 entitled Circuit Board Based Cable Connector, which is assigned to Masimo Corporation, Irvine, Calif. and incorporated by reference herein.

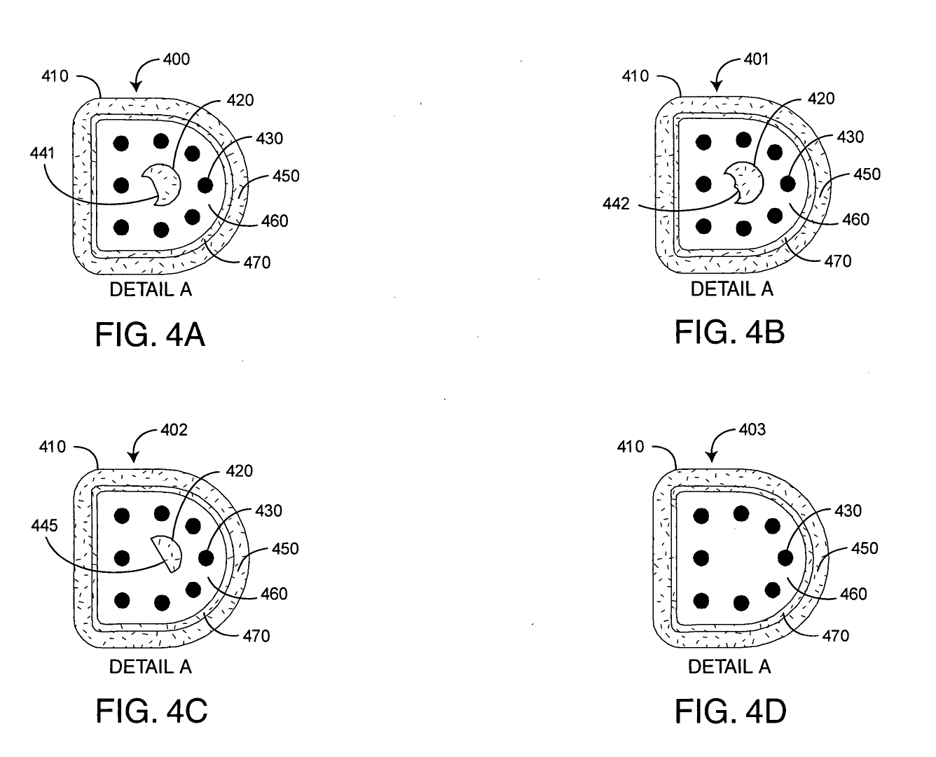

FIGS. 4A-D illustrate embodiments of a multiple key position plug 400-403 having an insulating D-shaped body 410 adapted to mate with a corresponding socket body 210 (FIGS. 2A-B). The plug body 410 has a shell 450 disposed around a recessed base 460. Extending from the base 460 and terminating somewhat recessed from the furthest extent of the outer shell 450 is a centered, generally cylindrical post 420. The post 420 is configured to insert into a corresponding socket cavity 220 (FIGS. 2A-B). Also extending from the base 460 and terminating somewhat recessed from the end of the post 420 are plug contacts 430, which are pins configured to insert into and electrically connect with corresponding socket contacts 230 (FIGS. 2A-B). A rim 470 somewhat recessed from the end of the plug contacts 430 delineates where the inner wall of the shell 450 narrows to provide a tight fit to the socket body 210 (FIGS. 2A-B). The multiple key position plug 400-403 has a fixed plug key 441-445 defined in the post 420 that accommodates a corresponding socket key 250, 260 (FIGS. 2A-B) at any of multiple key positions, such as illustrated in FIGS. 2A-B. In a particular embodiment, a patient cable 300 (FIG. 3B) utilizing a multiple key position plug 400-403 adapts a sensor (not shown) to a monitor (not shown) having either of the keyed sockets 200, 205 (FIG. 2A-B).

FIG. 4A illustrates one embodiment of a multiple key position plug 400 having a groove 441 with a crescent-shaped cross-section defined along the post 420. The groove 441 extends the length of the post 420 and accommodates either a 0° first position socket key 250 (FIG. 2A) or a 45° second position socket key 260 (FIG. 2B), as described above. In particular, the periphery of the groove 441 fits around the contour of a semi-circular cross-section socket key disposed at either of these key positions so that the post 420 clears the socket key 250, 260 (FIGS. 2A-B) as the plug 400 is inserted into a socket 200, 205 (FIGS. 2A-B).

FIG. 4B illustrates another embodiment of a multiple key position plug 401 having a groove 442 defined along the post 420 with a cross-section generally shaped as two overlapping semi-circles. The groove 442 extends the length of the post 420 and accommodates either a 0° first position socket key 250 (FIG. 2A) or a 45° second position socket key 260 (FIG. 2B), as described above. In particular, the periphery of the groove 442 fits around the contour of a semi-circular cross-section socket key 250, 260 (FIGS. 2A-B) disposed at either of these key positions so that the post 420 clears the socket key 250, 260 (FIGS. 2A-B) as the plug 401 is inserted into a socket 200, 205 (FIGS. 2A-B).

FIG. 4C illustrates yet another embodiment of a multiple key position plug 402 having a post 420 with substantially less than a circular cross-section, e.g. a semi-circular cross-section. As such, the post 420 accommodates either a 0° first position socket key 250 (FIG. 2A) or a 45° second position socket key 260 (FIG. 2B), as described above. In particular, the post 420 substantially clears the contour of a socket key 250, 260 (FIGS. 2A-B) disposed at either of these positions as the plug 402 is inserted into a socket 200, 205 (FIGS. 2A-B).

FIG. 4D illustrates yet another embodiment of a multiple key position plug 403 having a null post, i.e. a removed or missing post. As such, the plug 403 substantially accommodates either a 0° first position socket key 250 (FIG. 2A) or a 45° second position socket key 260 (FIG. 2B), as described above. In particular, there is no post to be blocked by a socket key 250, 260 (FIGS. 2A-B) disposed at either of these positions.

A multiple key position plug has been disclosed in detail in connection with various embodiments. These embodiments are disclosed by way of examples only and are not to limit the scope of the claims that follow. One of ordinary skill in the art will appreciate many variations and modifications.

What is claimed is:

1. In a cable adapted to provide communications between a sensor and a pulse oximeter, said sensor having emitters adapted to transmit at least two wavelengths of optical radiation into a fleshy tissue site and a detector responsive to said radiation after attenuation by pulsatile blood flowing within said fleshy tissue site so as to generate a sensor signal, said pulse oximeter adapted to transmit drive signals via said cable to said emitters and to receive said sensor signal via said cable from said detector so as to calculate a corresponding oxygen saturation measurement, a plug configured to mate with a corresponding socket mounted on said pulse oximeter so as to mechanically and electrically connect said cable to said pulse oximeter, said plug comprising:
an insulating plug body adapted to mesh with an insulating socket body of said socket;
a plurality of conductive plug contacts disposed within said plug body and adapted to insert into corresponding conductive socket contacts disposed within said socket body; and
a fixed plug key defined by said plug body, said plug key adapted to accommodate a socket key defined by said socket body at any of a plurality of key positions.

2. The plug according to claim 1 further comprising a generally cylindrical post extending from said plug body, said post configured to insert into a corresponding cavity defined within said socket body, wherein said plug key is a groove defined along said post and adapted to accommodate said socket key, wherein said socket key extends into said cavity.

3. The plug according to claim 2 wherein said groove is adapted to accommodate a socket key having a generally semi-circular cross-section at either a first position or a second position shifted 45° from said first position relative to an axis of said cavity.

4. The plug according to claim 3 wherein a cross-section of said groove has a generally crescent shape.

5. The plug according to claim 3 wherein a cross-section of said groove is generally shaped as two intersecting semicircles.

6. The plug according to claim 3 wherein said groove is at least a substantial portion of said post.

7. A plug method comprising the steps of:
providing a cable adapted to communicate signals between a sensor and a pulse oximetry monitor;
attaching a plug at a monitor end of said cable, said plug adapted to mate with a corresponding socket of said monitor, wherein said socket has a socket key located at one of a plurality of positions within said socket so as to block the insertion of an incompatible plug; and
configuring a fixed plug key so that said socket key does not block the insertion of said plug at any of multiple ones of said positions.

8. The plug method according to claim 7 wherein:
said socket comprises a generally cylindrical cavity configured to accept a generally cylindrical post of said plug; and
said configuring step comprising the substep of shaping at least a portion of said post so as to accommodate said socket key at said multiple ones of said positions.

9. The plug method according to claim 8 wherein said shaping substep comprises the substep of grooving said post according to a socket key located at either of two positions generally spaced 45° apart relative to an axis of said cavity.

10. The plug method according to claim 9 wherein said grooving substep comprises the substep of generally matching the cross-section of said groove to the contour of said socket key at each of said two positions.

11. A plug comprising:
a cable means for providing communications between a pulse oximeter and a sensor;
a plug body means for mating with a corresponding socket body disposed on said pulse oximeter;
a plurality of plug conductor means disposed in said plug body means for electrical connection between said cable means and a plurality of socket conductors disposed within said socket body;
a fixed plug key means defined in said plug body means for accommodating a socket key defined in said socket body at any of a plurality of positions.

12. The plug according to claim 11 wherein said fixed plug key means comprises:
a post means of said plug body means for inserting into a corresponding cavity of said socket body; and
a groove means for shaping said post means to clear said socket key at any of said positions.

13. A plug disposed on a monitor end of a patient cable, said patient cable having a plurality of conductors extending between said monitor end and a sensor end, said plug comprising:
a plug body adapted to mesh with a corresponding socket body disposed on a pulse oximeter;
a plurality of plug contacts disposed within said plug body and electrically connected to said conductors, said plug contacts adapted to mesh with a corresponding plurality of socket contacts disposed within said socket body so as to provide electrical communications between a sensor connected at said sensor end and said pulse oximeter connected at said monitor end; and
a fixed plug key of said plug body adapted to accommodate a socket key of said socket body disposed at any one of a plurality of key positions,
wherein said sensor comprises a plurality of emitters responsive to a drive signal communicated from said pulse oximeter so as to transmit light of at least two wavelengths into a tissue site having pulsatile blood flow and a detector responsive to said light after attenuation by said tissue site so as to generate a sensor signal communicated to said pulse oximeter, and
wherein said pulse oximeter is adapted to derive an oxygen saturation measurement from said sensor signal.

14. The plug according to claim 13 further comprising:
a post extending from said plug body, said post adapted to insert into a corresponding cavity extending into said socket body, wherein said socket key extends from a wall of said cavity,
said plug key comprising a groove defined by said post so as to accommodate said socket key at any of said positions.

15. The plug according to claim 14 wherein said post and said cavity are generally cylindrical and said groove has a generally crescent-shaped cross-section configured to accommodate a socket key having a generally semi-circular cross-sectioned disposed at either of a first position and a second position, where said second position is displaced generally 45° from said first position relative to an axis of said cavity.

16. The plug according to claim 13 wherein said plug key is a null post.
